(19) United States
(12) Patent Application Publication
(10) Pub. No.: US 2004/0023109 A1
(43) Pub. Date: Feb. 5, 2004

(54) One-piece lid supporting an insert-molded feedthrough assembly for an electrical energy storage device

(76) Inventors: Robert Rusin, Clarence, NY (US); James Roberts, Tonawanda, NY (US); James Biggs, East Aurora, NY (US); David Wutz, Williamsville, NY (US); David Panek, Alden, NY (US); Tina Urso, East Amherst, NY (US); Paul Hallifax, Gasport, NY (US); Dominick Frustaci, Williamsville, NY (US); David Warchocki, N. Tonawanda, NY (US)

Correspondence Address: Michael F. Scalise, Wilson Greatbatch Technologies, Inc., 10,000 Wehrle Drive, Clarence, NY, 14031, US

(21) Appl. No.: 10/630,014

(22) Filed: Jul. 30, 2003

Related U.S. Application Data
(63) Continuation-in-part of application No. 10/339,478, filed on Jan. 9, 2003.
Application No. 10/339,478 is a continuation-in-part of application No. 09/837,778, filed on Apr. 18, 2001, now abandoned.
(60) Provisional application No. 60/198,175, filed on Apr. 19, 2000.

(51) Int. Cl. H01M 2/08; H01M 2/02

(52) U.S. Cl. 429/180; 429/184; 429/175

(57) ABSTRACT

A unitary lid for the casing of an electrochemical energy storage device is described. The lid has a terminal lead ferrule and a fill port formed from a single blank in a machine process. The lid does not require any welding except for securing it to the open end of a casing container. The ferrule supports a terminal lead insulated therefrom by glass. A thermoplastic insulator material encases the ferrule and a portion of the terminal lead extending below the lid. In that manner, the insulator helps prevent contact between the anode and the cathode in the vicinity of the lid.

### CROSS-REFERENCE TO RELATED APPLICATIONS

This application is a continuation-in-part application of Ser. No. 10/339,478, filed Jan. 9, 2003, which is a continuation-in-part of application Ser. No. 09/837,778, now abandoned, which claims priority on U.S. provisional application Ser. No. 60/198,175, filed Apr. 19, 2000.

### FIELD OF THE INVENTION

The present invention relates to electrical energy storage devices, such as electrochemical cells and capacitors. More particularly, the present invention relates to lids or covers for casings housing electrical energy storage devices and feedthrough assemblies supported by the lids.

### BACKGROUND OF THE INVENTION

Electrochemical cells and capacitors typically include a container with an opening that is closed by a lid or cover welded to the container to form a casing for the electrical energy storage device. The lid must provide access to the interior of the casing for at least two purposes. First, a terminal lead connected to the anode or the cathode current collector must pass through one of the lid openings to a position exterior of the casing. Second, the electrolyte must be filled into the housing through the other lid opening. Conventionally, two openings are defined in the lid for this purpose. The openings usually have structures connected to the lid to aid in sealing them.

The container and the lid are of an electrically conductive material and serve as a contact for either the anode or the cathode electrode, typically the anode. The other of the anode and cathode electrodes not in contact with the casing, typically the cathode, is connected to a terminal lead electrically insulated from the casing by a glass-to-metal seal. The insulating glass is typically supported in the lid by a ferrule and the ferrule/insulating glass/terminal lead is referred to as a feedthrough assembly. A fill port sleeve/closure assembly is used for sealing the fill opening.

The provision of a sleeve-shaped terminal lead ferrule and fill port sleeve secured in respective openings in the lid introduces manufacturing steps into the process, which adds cost. The present lid and feedthrough assembly eliminates many of the conventional manufacturing steps by machining the lid from a metal blank. Not only does this save production costs, but also the machining process roughens the inner surface of the terminal ferrule, which, in turn, benefits adhesion of the glass-to-metal seal to the ferrule material. Then, this assembly is easily loaded into a mold assembly to provide a thermoplastic insulating enclosure encasing the ferrule and part of the terminal lead. The thusly-formed insulator helps segregate the anode from the cathode in the vicinity of the lid.

### SUMMARY OF THE INVENTION

The present invention provides a unitary lid including a terminal ferrule and a fill port structure formed from a single blank of conductive material. A starting blank is provided with a thickness sufficient to meet the design features for a particular electrical energy storage device. The terminal ferrule and fill port are then created in the blank via a machining process such that the junctions where both the terminal lead ferrule and the fill port structure meet with the under side of the lid are at right angles. The process of the present invention eliminates the need for welding of the sleeve-shaped terminal lead ferrule and fill port, and requires fewer handling operations while optimizing the cell's internal volume. To further isolate the anode from the cathode, a thermoplastic material encases the ferrule and a portion of the length of the terminal lead.

These and other aspects of the present invention will become increasingly more apparent to those skilled in the art by reference to the following description and the appended drawings.

### BRIEF DESCRIPTION OF THE DRAWINGS

FIG. 1 is a cross-sectional, side elevational view of a unitary lid of the present invention.

FIG. 2 is a cross-sectional view taken along line 2-2 of FIG. 1.

FIG. 3 is a cross-sectional, side elevation view of an exemplary electrochemical cell with the unitary lid of the present invention supporting a feedthrough assembly for a terminal lead connected to one of the electrodes and with the lid attached to a container to provide a casing for the cell.

FIG. 4 is a cross-sectional, side elevational view of the lid supporting the feedthrough assembly.

FIG. 5 is a cross-sectional view of a mold assembly for providing an insulator material encapsulating a ferrule and part of a terminal lead for the feedthrough assembly.

FIG. 6 is a cross-sectional view taken along line 6-6 of FIG. 5 prior to the insulator material being injected into the mold.

FIG. 7 is a cross-sectional view similar to FIG. 6, but with the insulator material encasing the ferrule and terminal lead.

FIG. 8 is a cross-sectional view illustrating a further embodiment of the present invention.

### DETAILED DESCRIPTION OF THE EMBODIMENTS

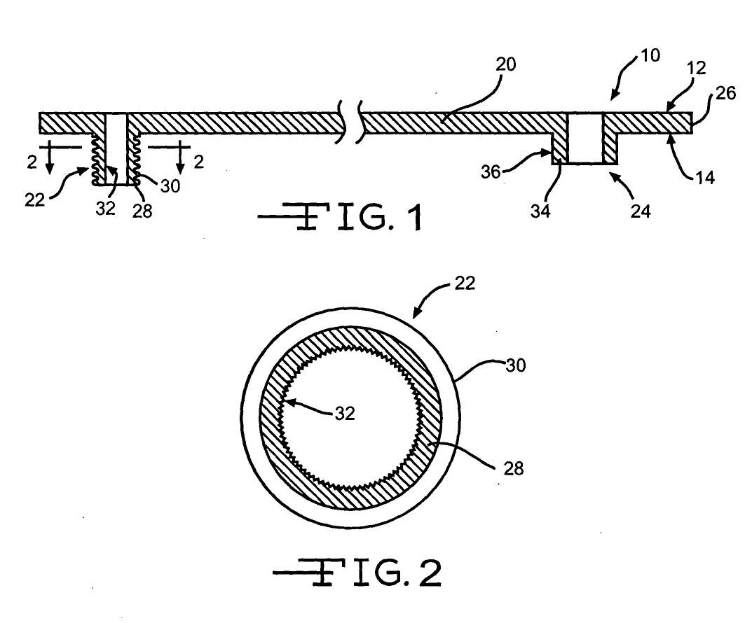

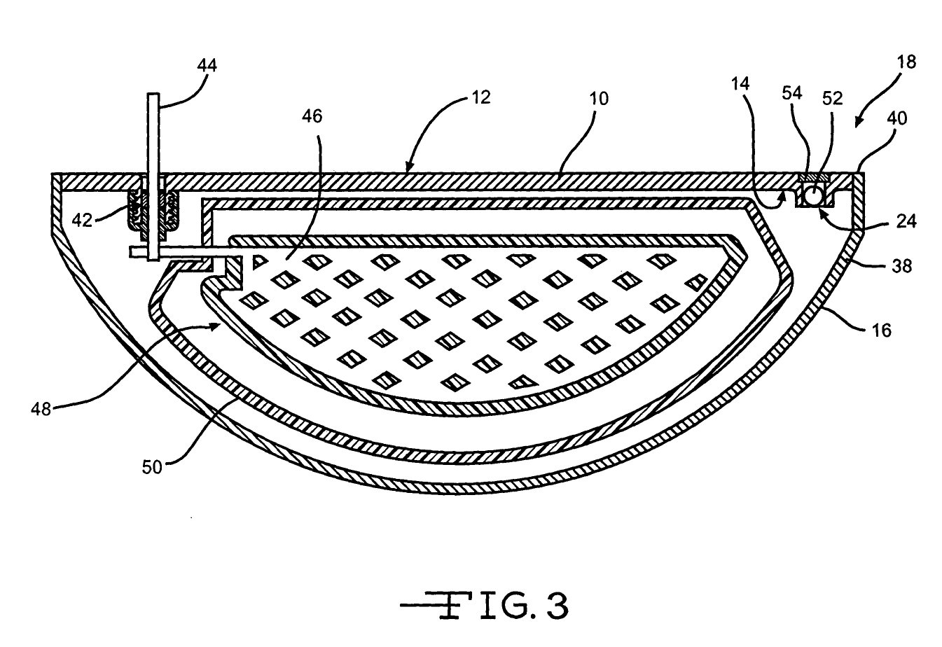

Throughout this description the terms “lid” and “cover” are used interchangeably to refer to the member shown in FIGS. 1 and 2 that is attached to the open end of a container or housing to form a casing for an electrical energy storage device.

Electrochemical cells or batteries generate electrical current from chemical energy. Capacitors are used to store relatively large quantities of electrical energy for subsequent discharge. Often, these types of electrical energy storage devices are used in medical devices such as heart pacemakers, cardiac defibrillators, neurostimulators, cochlear implants, and the like. In that light, the lid of the present invention is a compact unitary member with space saving right angle surfaces at the junction of the lid body and both the terminal ferrule and the fill port. As will be described hereinafter, this makes the present lid particularly applicable for electrical energy storage devices intended for incorporation into implantable medical devices.

Turning now to the drawings, FIG. 1 shows a unitary lid or cover 10 according to the present invention formed by machining a rectangular blank (not shown) of an electrically conductive material such as stainless steel, titanium, nickel, aluminum, and the like. Lid 10 has generally opposing major planar upper and lower surfaces 12 and 14. When in place closing the open end of the container 16 of a casing 18 (FIG. 3), the upper surface 12 is an exterior surface and inner or lower surface 14 is an interior surface.

Lid 10 is formed of generally three portions or regions: a main body portion 20 having the opposed upper and lower surfaces 12, 14, a terminal ferrule portion 22, and a fill port portion 24. The terminal lead ferrule 22 and the fill port portion 24 are completely integral or unitary with main body portion 20. As used herein, completely integral means being of a single continuous body of material. In other words, by machining the lid 10 from a suitable blank, the terminal ferrule 22 and the fill port portion 24 are not separate or discrete parts, but rather are completely unitary with the main body portion 20 forming a single part.

Lid 10 terminates along a peripheral edge 26 that is generally perpendicular to the planar upper and lower lid surfaces 12, 14. In the embodiment shown, main body portion 20 is generally rectangular in peripheral shape. The terminal ferrule 22 is a sleeve-shaped portion having a generally cylindrically shaped surrounding sidewall 28 with a series of annular rings 30 extending from the inner surface 14 to a distal end thereof. The cylindrically shaped inner surface 32 of the surrounding sidewall has a machined roughened texture. In other words, the inner surface 32 is not threaded, but is roughened by the action of a rotating machining bit removing material from the blank to form the cylindrically shaped opening. The machined roughness enhances the integrity of the glass-to-metal seal by providing scoring marks that serve as attachment structures for the glass 33 (FIG. 8) to fill and anchor into.

The ferrule sidewall 28 meets the lower surface 14 of the lid main body portion 20 at a right angle or a normal orientation. Similarly, the fill port 24 is a sleeve-shaped portion having a cylindrically shaped opening provided by a surrounding sidewall 34. The cylindrical outer surface 36 of the fill port sidewall 34 meets the lower surface 14 of the lid main body portion 20 at a right angle.

While the upper ends of the terminal ferrule 22 and the fill port 24 are shown co-planar with the upper surface 12 of the lid 10, the present invention should not be so limited. In that respect, these structures can extend above the upper lid surface 12. What is important is that they are unitary with the main body portion 20.

It will be understood by those of ordinary skill in the art that the main body portion 20 of the lid 10 may be of any suitable shape to mate with and close an opening in the container 16 for the casing 18, which also may be of any suitable shape. Therefore, the present invention contemplates any configuration of two portions of an electrical energy storage device casing which when mated form a cavity therein. This includes casings of a cylindrical shape, prismatic shape, button shape and a casing formed of mating “clam shell” portions, such as described in U.S. application Ser. No. 09/757,232, filed Jan. 9, 2001. This application is assigned to the assignee of the present invention and incorporated herein by reference.

Either one of such portions of the casing 18, i.e., the lid 10 or the container 16, or either one of the mating clam shell portions of the above-referenced patent application, may include the terminal ferrule portion 22 and the fill port portion 24 and be formed as a single part. What is important is that the respective cylindrically-shaped sidewalls 28, 36 of the terminal ferrule 22 and the fill port 24 meet the lower or inner surface 14 of the lid main body portion 20 at a normal orientation. This means that as little internal casing volume as possible is occupied by the unitary lid 10. Such a construction benefits volumetric cell efficiency, which is especially important in electrical energy storage devices intended for incorporation in implantable medical devices.

FIG. 3 shows an illustrative exemplary electrochemical cell incorporating a lid or cover 10 according to the present invention. The exemplary cell is described in U.S. Pat. No. 5,750,286 to Paulot et al., which is assigned to the assignee of the present invention and incorporated herein by reference. The cell includes the casing 18 made of metal, such as stainless steel, titanium, nickel, aluminum, or other suitable electrically conductive material. Casing 18 is formed of two portions: the container 16 and the lid 10. Container 16 has a sidewall 38 terminating at a peripheral edge or rim 40 defining an opening leading into the container. Lid 10 closes this opening when it is attached to the peripheral edge 40, such as by welding.

As shown in FIGS. 3 to 7, the terminal ferrule 22 supports a glass-to-metal seal 42 for a terminal lead 44 connected to the current collector 46 of one of the electrodes, for example the cathode electrode 48. The anode (not shown) is segregated from the cathode by a separator 50. The anode/cathode electrode assembly is then activated by an electrolyte (not shown) filled in the casing, and sealed therein by a closure means, such as ball 52 and sealing disc 54 sealed in the fill port portion 24 of the lid 10. Those skilled in the art will understand that the present invention is not limited to any particular closure structure.

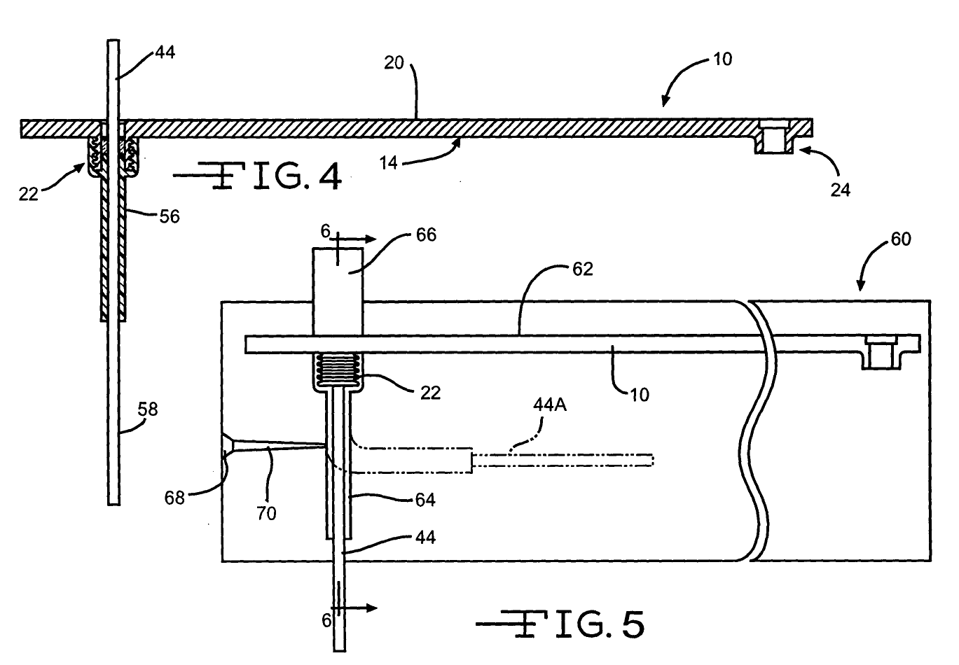

FIG. 4 further shows a thermoplastic insulator 56 encasing the ferrule 22 and a portion of the terminal lead 44. A preferred thermoplastic material is a fluoropolymer, for example polytetrafluoroethylene (PTFE) that surrounds the ferrule 22 from the lower surface 14 of the lid 10 and continues along a portion of the length of the terminal lead 44 to a distance spaced from the ferrule. The annular rings 30 of the ferrule 22 provide a discontinuous pathway that helps maintain a hermetic seal between the thermoplastic insulator and the ferrule. Also, thermoplastic materials generally flow better around and into annular rings than traditional threads. A lower portion 58 of the terminal lead 44 is left uncovered for subsequent connection to the cathode current collector 46, as described above. The primary function of the insulator 56 is to help segregate the anode from the cathode adjacent in the vicinity of the lid 10.

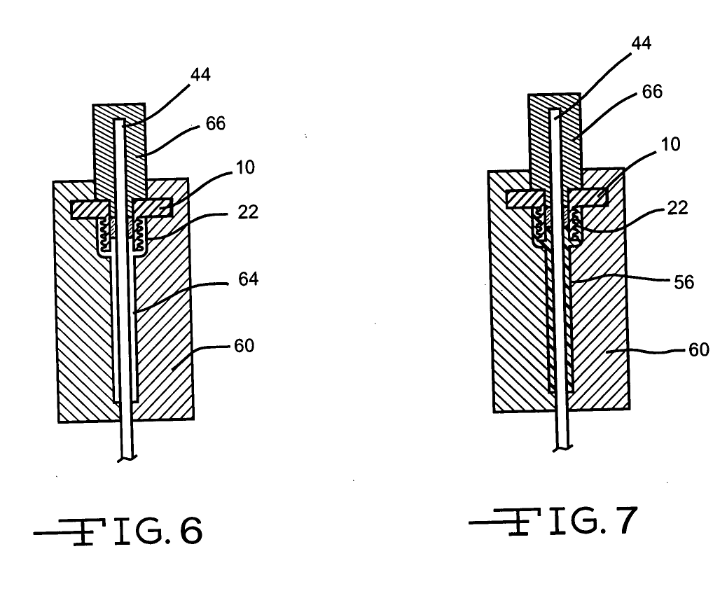

FIGS. 5 and 6 illustrate a mold assembly 60 for providing the thermoplastic insulator 56 surrounding the ferrule 22 and terminal lead 44. The mold assembly 60 has a cavity 62 sized to precisely enclose the lid 10. The mold 60 provides an annulus 64 about the ferrule 22 and the terminal pin 44. The annulus 64 is only present about the terminal pin 44 to the length that is desired for the insulator to encase the terminal pin. The mold 60 receives a plug 66 that blanks off the inner surface of the ferrule 22 above the glass-to-metal seal insulating the terminal lead 44 from the ferrule.

FIG. 5 also illustrates an alternate embodiment of the terminal lead 44A (shown in dashed lines) having a right angle bend partway through that portion of its length that will be encased by insulator 56. Those skilled in the art will understand that the terminal lead can have various orientations and still be at least partially encased by the insulator material.

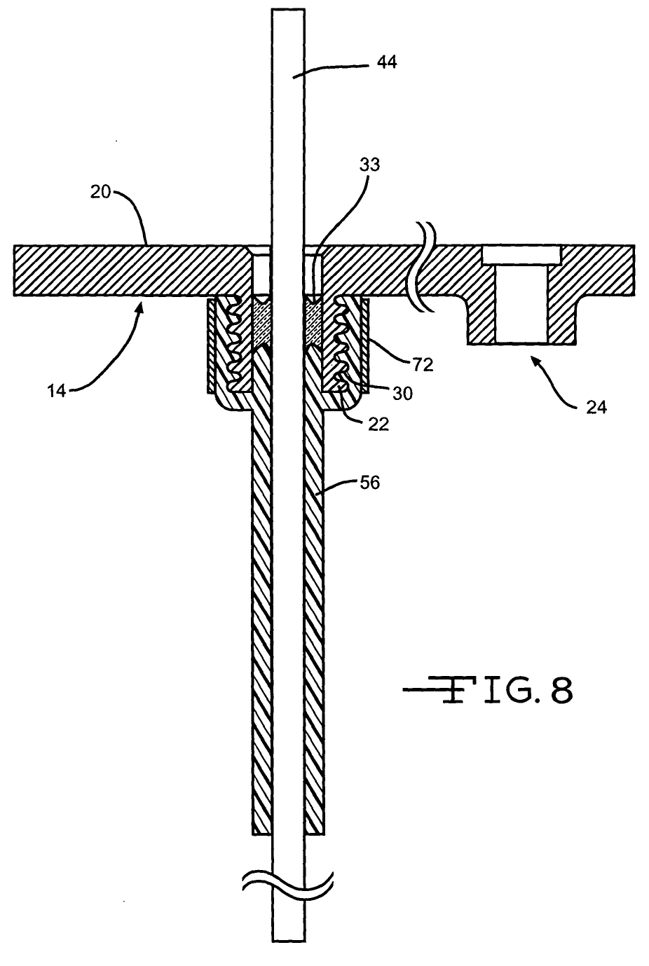

FIG. 7 shows the insulator material 56 having been injected into the mold assembly 60 through a sprue 68 and gate 70 leading to the annulus 64. The thermoplastic material 56 fills the entire void of the annulus 64 to surround the ferrule 22 including the annular rings 30 and a portion of the length of the terminal lead 44. In this manner, the insulator 56 encases the terminal lead 58 supported by the glass-to-metal seal 42, which, in turn, is supported by the ferrule portion 22 of the unitary lid 10. The insulator 56 in conjunction with the separator 50 prevents the anode electrode from contacting the cathode electrode.

FIG. 8 illustrates a further embodiment of the present invention. An annul ring 72 surrounds and contacts the thermoplastic material 56 encasing the annular rings 30 of terminal ferrule 22. The annual ring 72 is preferably of a metal material and promotes hermetically between the thermoplastic material 56 and the terminal ferrule.

In accordance with the previous description, it will be evident that the present invention is applicable to any type of electrical energy storage device in which a housing is used that has a container portion with an open side and a lid for closing the container, thereby forming a casing for the storage device. In that respect, the present invention is applicable to low rate, medium rate, high rate, case negative and case positive electrochemical cells of both primary and secondary chemistries. Examples of such cells include lithium iodine cells, lithium thionychloride cells, lithium silver vanadium oxide cells, lithium carbon monofluoride cells, lithium manganese dioxide cells, and secondary cells containing lithium cobalt oxide, and the like.

It will further be recognized that such cells may take one of various configurations. For example, depending on the type of cell, the configuration of the anodes, cathodes, terminal lead ferrule portions, fill ports, etc. will vary. Also, for example, depending on the cell, the materials housed in the casing will vary. Such materials may take the form of a liquid or a solid depending on the type of cell. Therefore, it should be clear that the present invention is in no manner limited to the illustrative cell described herein and is applicable to all types of electrochemical chemistries.

The present invention is also applicable to capacitors, such as those described in U.S. Pat. Nos. 5,926,362 and 6,334,879, both to Muffoletto et al. These patents are assigned to the assignee of the present invention and incorporated herein by reference.

It is appreciated that various modifications to the inventive concepts described herein may be apparent to those of ordinary skill in the art without departing from the spirit and scope of the present invention as defined by the appended claims.

What is claimed is:

1. An electrical energy storage device, which comprises:
a) a container having a surrounding side wall providing an opening leading into the container;
b) an electrode assembly comprising an anode and a cathode in a electrochemical association with each other inside the container;
c) a lid having spaced apart upper and lower surfaces joined by a peripheral edge and secured to the open end of the container to provide a casing housing the electrode assembly, wherein the lid has at least a unitary terminal ferrule extending below the lid lower surface with an inner surface of the terminal ferrule characterized by a roughened texture;
d) a terminal lead extending through the terminal ferrule and having a length providing a first end position spaced above the upper surface of the lid and a second end connected to one of the anode and the cathode electrodes, wherein the terminal lead is sealed in the terminal ferrule in an insulated relationship therewith;
e) an insulator encasing the terminal ferrule and at least a portion of the length of the terminal lead disposed inside the casing; and
f) an electrolyte provided in the casing to activate the anode and cathode electrodes.

2. The electrical energy storage device of claim 1 wherein the insulator is of a thermoplastic fluoro-polymer material.

3. The electrical energy storage device of claim 1 wherein an outer surface of the ferrule is provided with a series of annular rings encased by the insulator.

4. The electrical energy storage device of claim 1 wherein the inner surface of the terminal ferrule has a machined roughened texture.

5. The electrical energy storage device of claim 1 including an annular ring surrounding the insulator encasing the terminal ferrule.

6. The electrical energy storage device of claim 1 wherein the lid has a unitary fill port extending below the lid lower surface.

7. The electrical energy storage device of claim 1 wherein the lid is of a conductive material selected from the group consisting of stainless steel, titanium, nickel and aluminum.

8. The electrical energy storage device of claim 1 as either an electrochemical cell or a capacitor.

9. A lid for closing an open end of a casing for an electrochemical energy storage device, the lid having a terminal ferrule supporting a terminal lead extending therethrough, wherein the terminal lead has a length providing a first end positioned spaced above the upper surface of the lid and a second end extending below the lid lower surface, and wherein the terminal lead is sealed in an insulated relationship in the terminal ferrule with an insulator encasing the terminal ferrule and at least a portion of the length of the terminal lead extending below the lid lower surface, the improvement in the lid comprising:
spaced apart upper and lower surfaces joined by a peripheral edge, wherein the terminal ferrule is a unitary portion of the lid extending below the lid lower surface with an inner surface of the terminal ferrule characterized by a roughened texture.

10. The lid of claim 9 wherein the insulator is of a thermoplastic fluoro-polymer material.

11. The lid of claim 9 wherein an outer surface of the ferrule is provided with a series of annular rings encased by the insulator.

12. The lid of claim 9 wherein the inner surface of the terminal ferrule has a machined roughened texture.

13. The lid of claim 9 including an annular ring surrounding the insulator encasing the terminal ferrule.

14. An implantable medical device, which comprises:
a) a device container;
b) a control circuitry; and
c) an electrical energy storage device, wherein the control circuitry and the electrical energy storage device are housed in the device container, the electrical energy storage device comprising:
i) a container having a surrounding side wall providing an opening leading into the container;
ii) an electrode assembly comprising an anode and a cathode in electrochemical association with each other disposed inside the container;
iii) a lid having spaced apart upper and lower surfaces joined by a peripheral edge and secured to the open end of the container to provide a casing housing the electrode assembly, wherein the lid has at least a unitary terminal ferrule extending below the lid lower surface with an inner surface of the terminal ferrule characterized by a roughened texture;
iv) a terminal lead extending through the terminal ferrule and having a length providing a first end positioned spaced above the upper surface of the lid and a second end connected to one of the anode and the cathode electrodes, wherein the terminal lead is sealed in the terminal ferrule in an insulated relationship therewith;
v) an insulator encasing the terminal ferrule and at least a portion of the length of the terminal lead disposed inside the casing; and
vi) an electrolyte provided in the casing to activate the anode and cathode electrodes.

15. A method for providing a lid assembly for a casing of an electrochemical energy storage device, comprising the steps of:
a) obtaining a blank;
b) machining the blank to provide the lid having spaced apart upper and lower surfaces joined by a peripheral edge, and a unitary terminal ferrule extending below the lid lower surface;
c) positioning a terminal lead in the terminal ferrule in an insulated relationship therewith by an insulating glass sealing between the terminal lead and the terminal ferrule, wherein the terminal lead has a length providing a first end positioned spaced above an upper surface of the lid and a second end spaced below a lower lid surface; and
d) encasing the ferrule and at least a portion of the length of the terminal lead extending below the lower lid surface in an insulative material.

16. The method of claim 15 including providing the insulator of a thermoplastic fluoro-polymer material.

17. The method of claim 15 including providing an outer surface of the ferrule having a series of annular rings encased by the insulator.

18. The method of claim 15 including machining the terminal ferrule having an inner surface with a machined roughened texture.

19. The method of claim 15 including providing an annular ring surrounding the insulator encasing the terminal ferrule.

20. A method for providing an electrical energy storage device, comprising the step of:
a) providing a container having a surrounding side wall with an opening leading into the container;
b) disposing an electrode assembly comprising an anode and a cathode in electrochemical association with each other inside the container;
c) machining a blank to provide a lid having spaced apart upper and lower surfaces joined by a peripheral edge and at least a unitary terminal ferrule extending below the lid lower surface, wherein an outer surface of the terminal ferrule is in a normal orientation with the lid lower surface;
d) sealing a terminal lead extending through the terminal ferrule, the terminal ferrule having a length providing a first end spaced above the upper surface of the lid and a second end extending below the lid lower surface, wherein the terminal lead is sealed in the terminal ferrule in an insulated relationship therewith;
e) providing an insulator encasing the terminal ferrule and at least a portion of the length of the terminal lead extending below the lower lid surface;
f) connecting the portion of the terminal lead extending below the lid lower surface to one of the anode and cathode electrodes;
g) securing the lid to the container to close the opening leading therein and thereby providing a casing for the electrical energy storage device; and
h) activating the anode and cathode electrodes with an electrolyte provided in the casing.

21. The method of claim 20 including providing the insulator of a thermoplastic fluoro-polymer material.

22. The method of claim 20 including providing an outer surface of the terminal ferrule with a series of annular rings encased by the insulator.

23. The method of claim 20 including machining the terminal ferrule having an inner surface with a machined roughened texture.

24. The method of claims 20 including providing an annular ring surrounding the insulator encasing the terminal ferrule.

25. The method of claim 20 including machining the blank having a unitary fill port extending below the lid lower surface.
